(19) United States
(12) Patent Application Publication
(10) Pub. No.: US 2003/0134611 A1
(43) Pub. Date: Jul. 17, 2003

(54) Local oscillator balun using inverting circuit

(76) Inventors: Mun Yang Park, Yuseong-Gu (KR); Seong Do Kim, Yuseong-Gu (KR); Hyun Kyu Yu, Yuseong-Gu (KR); Kyung Soo Kim, Seo-Gu (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/179,748

(22) Filed: Jun. 24, 2002

(30) Foreign Application Priority Data
Jan. 16, 2002 (KR) 2002-2493

(51) Int. Cl. H04B 1/26; H04B 7/00

(52) U.S. Cl. 455/265; 455/318

(57) ABSTRACT

The present invention relates to a local oscillator balun using an inverting circuit. The local oscillator balun using an inverting circuit comprises a complementary output converting circuit for amplifying a weak signal as a single signal from a local oscillator to produce two signals; a differential amplification circuit for producing two signals having a given amplitude from the two signals of said complementary output converting circuit; and an inverting circuit for inverting the two signals of the differential amplification circuit. Thus, a complementary signal having the maximum amplification and small phase difference can be produced. Therefore, the present invention can implement the maximum gain and small local oscillating leakage of the frequency mixer in a Gilbert type high frequency double balance frequency mixer.

### BACKGROUND OF THE INVENTION

1 Field of the Invention

The invention relates generally to a local oscillator balun using an inverting circuit. More particularly, it relates to a local oscillator balun using an inverting circuit capable of accomplishing the maximum gain and the decrease of the leakage current of the frequency mixer, in such a way that a single input signal of a weak local oscillator of −15˜−5 dbm externally inputted is amplified in a local oscillating frequency input terminal of a Gilbert type double balance frequency mixer having good mixing gain and noise characteristics and then the signal is converted into the complementary signal, the complementary signal of a high amplitude that can perform a switching operation and the complementary signal having an exact phase difference of 180 degree are supplied to the local oscillating frequency input terminal of a Gilbert type frequency mixer having very high capacitive load and resistive load.

2. Description of the Prior Art

Wireless transmitter/receiver is a system that allows to communicate via air without wires between distances spaced apart. At this case, for the acquisition of quality and reliability of transmitted information, modulation and demodulation are performed. The modulation is performed by carrying the signal on a local oscillating frequency of a high frequency, and demodulation is performed by reproducing the original signal from the received signal by removing the local oscillating frequency. The transmission/reception frequency mixer for performing these modulation and demodulation operation is an important part in determining the quality of communication of the wireless transmitter/receiver.

A construction of the system including the reception frequency mixer is shown in FIG. 1.

The system includes a high frequency input circuit 10 for receiving a high frequency signal (RF), a local oscillating signal input circuit 20 for receiving a local oscillator signal (LO), a frequency mixer 30 for converting the frequency using the signals, and an intermediate frequency driving output circuit 40 for outputting an intermediate frequency signal (IF).

The transmission/reception frequency mixers are same in structure. The reception frequency mixer, however, converts the modulated high frequency signal (ωRF) into the intermediate frequency (ωIF) using the local oscillator frequency (ωLO), that is, obtains the characteristic of the intermediate frequency (ωIF=ωRF−ωLO. Meanwhile, the transmit frequency mixer converts the modulated intermediate frequency (ωIF) into the high frequency signal (ωRF) using the local oscillator frequency (ωLO), that is obtain the characteristic of obtain ωRF=ωLO+ωIF.

This type of the frequency mixer usually employs a passive frequency mixer that has a good linearity but a low conversion gain and a bad noise characteristic. A mixer that is currently widely used in the integrated circuit, however, is an active frequency mixer basically including a Gilbert multi flier type that has good mixing gain and noise characteristics and that can be easily integrated.

FIG. 2 is a simplified circuit diagram of a double balance frequency mixer of a Gilbert type that does not represent a bias voltage input, the structure of which will be described.

First and second resistors R21 and R22 in a load resistor 31 are connected between the power supply terminal Vcc, and first and second nodes Q21 and Q22, respectively. A first NMOS transistor N21 driven depending a first local oscillating signal LO+ is connected between the first node Q21 and the third node Q23. A second NMOS transistor N22 driven depending on a second local oscillating signal LO− is connected between the third node Q23 and the second node Q22. A third NMOS transistor N23 driven depending on the first local oscillating signal LO+ is connected between the third node Q23 and the fourth node Q24. A fourth NMOS transistor N24 driven depending on the second local oscillating signal LO− is connected between the first node Q21 and the fourth node Q24. A fifth NMOS transistor N25 driven depending on a first high frequency signal RF+ is connected between the third node Q23 and a ground terminal Vss. A sixth NMOS transistor N26 driven depending on a second high frequency signal RF− is connected between the fourth node Q24 and the ground terminal Vss. At this time, the first node Q21 is an output terminal of the first intermediate frequency signal IF+ and the second node Q22 is an output terminal of the second intermediate frequency signal IF−. Further, capacitors are connected to respective input/output terminals. A first capacitor C21 is connected to an output terminal of a first intermediate frequency signal IF+, a second capacitor C22 is connected to an output terminal of a second intermediate frequency signal IF−, a third capacitor C23 is connected to an input terminal of a first local oscillating signal LO+, a fourth capacitor C24 is connected to an input terminal of the second local oscillating signal LO−, a fifth capacitor C25 is connected to an input terminal of a first high frequency signal RF+, and a sixth capacitor C26 is connected to an input terminal of the second high frequency signal RF−.

The double balance frequency mixer of a Gilbert type constructed above is usually composed of an upper stage, a lower stage, etc. two stages. The local oscillating frequency input terminal at the upper stage that needs to perform a switching operation, and the transmit frequency mixer at the lower state that needs to perform a linear operation are used as a high frequency (RF) input. The reception frequency mixer is used as the intermediate frequency (IF) stage. In view of the circuit, the local oscillator frequency input terminal is composed of high capacitive and resistive loads.

In the system shown in FIG. 1, the local oscillator balun is used to generate a complementary output of a high amplitude and a signal having the phase difference of 180 degree in order to obtain a high mixing gain and a low leakage characteristic, by connecting a weak signal of a single input inputted to the local oscillator to the local oscillating frequency input circuit of the double balance frequency mixer of high capacitive and resistive loads.

In order to implement this, in case of a conventional circuit, a complementary mixing circuit of a signal input for implementing the above is constructed, two stages or three stages are connected, a LC parallel resonance circuit is used as a load for improving the amplication and voltage head room of the output voltage, a structure of an output terminal load is changed, etc. For example, the circuit shown in FIG. 3 is a circuit diagram of the conventional local oscillator balun 20. The circuit includes a complementary output converting circuit 21 of a single input and a differential amplification circuit 22 for determining an output signal depending on the output signal of the circuit 21.

The structure of the circuit in FIG. 3 will be below described. A construction of the complementary output converting circuit 21 of a single input will be first described. First and second resistors R31 and R32 are connected between the power supply terminal Vcc, and first and second nodes Q31 and Q32. A first NMOS transistor N31 to a gate terminal of which is applied with a local oscillating signal LO and a specific bias voltage VB through a third resistor R33 is connected between the first node Q31 and the third node Q33. A second NMOS transistor N32 to a gate terminal of which is applied with a specific bias voltage VB via the ground terminal Vss and a fourth resistor R34 is connected between the second node Q32 and the third node Q33. Third and fourth NMOS transistors N33 and N34 driven depending on a given bias are serially connected between the third node Q33 and the ground terminal Vss. A first capacitor C31 is connected between an input terminal of the local oscillating signal LO and the gate terminal of the first NMOS transistor N31. A second capacitor C32 is connected between the ground terminal Vss and the gate terminal of the second NMOS transistor N32. A third capacitor C33 is connected between the gate terminal of the fourth NMOS transistor N34 and the ground terminal Vss. The potential of the first node Q31 is the first output signal O1+ and the potential of the second node Q32 is the second output signal O1−.

The construction of the differential amplification circuit 22 will be below described. Firth and sixth resistors R35 and R36 are connected between the power supply terminal Vcc, and fourth and fifth nodes Q34 and Q35, respectively. A fifth NMOS transistor N35 driven depending on the second output signal O1− is connected between the fourth node Q34 and the sixth node Q36. A sixth NMOS transistor N36 driven depending on the first output signal O1+ is connected between the fifth node Q35 and the sixth node Q36. Further, a seventh NMOS transistor N37 driven depending on a given bias is connected between the sixth node Q36 and the ground terminal Vss. A fourth capacitor C34 is connected between an input terminal of the second output signal O1− and the gate terminal of the fifth NMOS transistor N35. A fifth capacitor C35 is connected between an input terminal of the first output signal O1+ and the gate terminal of the sixth NMOS transistor N36. Further, a specific bias voltage VB via the seventh resistor R37 is supplied to the gate terminal of the fifth NMOS transistor N35. A specific bias voltage VB via the eighth resistor R38 is supplied to the gate terminal of the sixth NMOS transistor N36. In the above, the fourth node Q34 is the first output terminal OUT+ and the fifth node Q35 is the second output terminal OUT−.

In the local oscillator balun constructed above, as the load of the local oscillating frequency input terminal in the frequency mixer is actually great, it is difficult to design the local oscillator balun having a signal of a high amplitude and a complementary output of an exact phase difference of 180 degree, as shown in FIG. 6.

### SUMMARY OF THE INVENTION

The present invention is contrived to solve the above problems and an object of the present invention is to implement the maximum gain and local oscillating leakage of the frequency mixer by implementing a local oscillator balun using an inverting circuit in providing a local oscillating frequency to a Gilbert type double balance frequency mixer in a frequency mixer for wireless communication system, in order to obtain a complementary output having the maximum amplification and lower phase difference in the local oscillating frequency output.

In the present invention, a single input signal of a weak local oscillator of −15˜−5 dBm externally inputted is amplified in a local oscillating frequency input terminal of a Gilbert type double balance frequency mixer having good mixing gain and noise characteristics. After the signal is converted into the complementary signal, the complementary signal of a high amplitude that can perform a switching operation and the complementary signal having an exact phase difference of 180 degree are supplied to the local oscillating frequency input terminal of a Gilbert type frequency mixer having very high capacitive load and resistive load, thus accomplishing the maximum gain and reduction in the leakage signal of the frequency mixer.

In order to accomplish the above object, a local oscillator balun using an inverting circuit according to the present invention, is characterized in that it comprises a complementary output converting circuit for amplifying a weak signal as a single signal from a local oscillator to produce two signals; a differential amplification circuit for producing two signals having a given amplitude from the two signals of said complementary output converting circuit; and an inverting circuit for inverting the two signals of the differential amplification circuit.

### BRIEF DESCRIPTION OF THE DRAWINGS

The aforementioned aspects and other features of the present invention will be explained in the following description, taken in conjunction with the accompanying drawings, wherein:

FIG. 1 is a block diagram of a system having a receive frequency mixer;

FIG. 2 is a circuit diagram of a Gilbert double balance frequency mixer;

FIG. 3 is a circuit diagram of a conventional local oscillator balun;

FIG. 4 is a circuit diagram of a local oscillator balun using an inverting circuit according to a first embodiment of the present invention;

FIG. 5 is a circuit diagram of a local oscillator balun using an inverting circuit according to a second embodiment of the present invention;

FIG. 6 shows an output waveform of a conventional local oscillator; and

FIG. 7 shows an output waveform of the local oscillator balun using an inverting circuit according to the embodiment of the present invention.

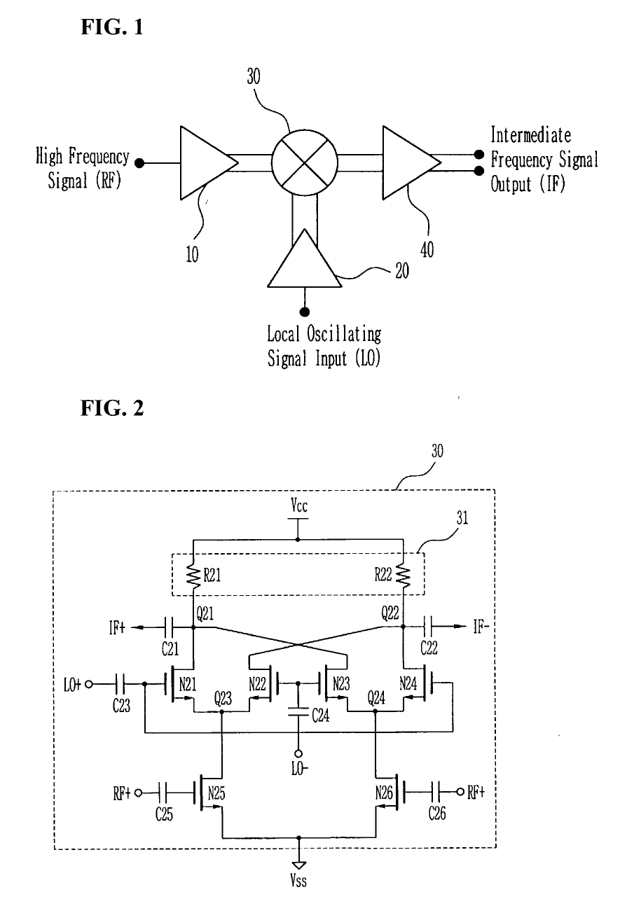

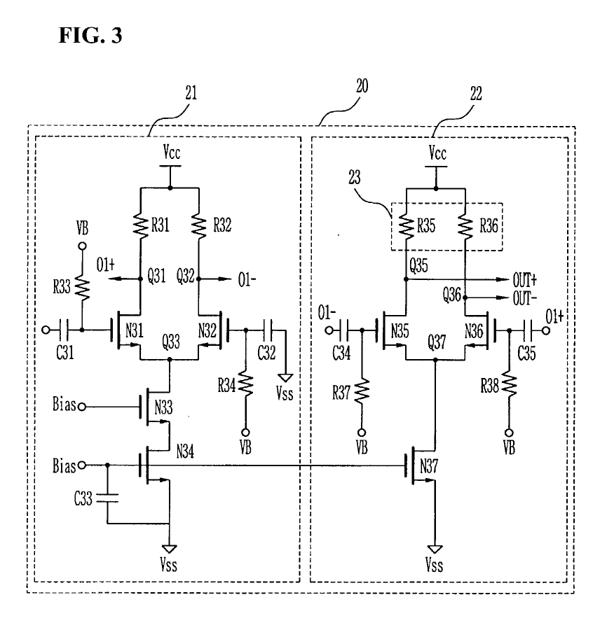

### DETAILED DESCRIPTION OF PREFERRED EMBODIMENTS

The present invention will be described in detail by way of a preferred embodiment with reference to accompanying drawings, in which like reference numerals are used to identify the same or similar parts.

In an operation of a double balance active frequency mixer of a Gilbert type shown in FIG. 2, if a signal of a high amplitude capable of performing a switching operation for the device is applied to a local oscillating frequency input terminal LO, thereby a MOS transistor at an upper stage is ideally switched, and the gain is the maximum, 2/π and the output frequency is ωIF=ωRF−ωLO can be obtained.

In other words, a reception frequency mixer, if the RF input signal is A_{IN} sin (ω_{IN}t) and the local oscillating frequency input is A_{LO} sin (ω_{LO}t), the output signal of the frequency mixer can be expressed as [Equation 1].

A_{IN}A_{LO}/A_{REF}[cos((ω_{LO}−ω_{IN})t)−cos((ω_{LO}+ω_{IN})t)] [EQUATION 1]

At this case, the mixing gain of the frequency mixer can be expressed into [Equation 2].

MixerConversionGain=A_{IN}·A_{LO}/A_{REF} [EQUATION 2]

From [Equation 1] and [Equation 2], the high amplitude of a local oscillating frequency (LO) makes the mixing gain of the frequency mixer increased.

Further, the phase difference in a complementary output of the local oscillating frequency inputted to the frequency mixer also greatly affects leakage of the local oscillating frequency of the frequency mixer output, removal of the image, noise of system, and the like. Due to this, a system of a good performance can be completed in which the phase difference of the complementary output at the local oscillating frequency stage is controlled to be small.

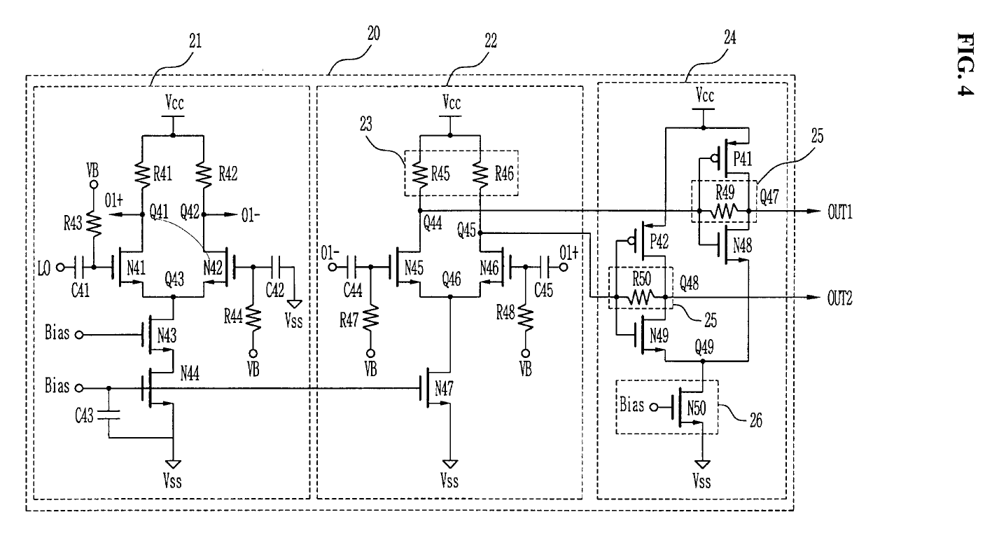

The inverting circuit is applied in the embodiment, as shown in FIG. 4.

FIG. 4 is a circuit diagram of a local oscillator balun using an inverting circuit according to a first embodiment of the present invention. The local oscillator balun includes a complementary output converting circuit 21 of a single input, a differential amplification circuit 22, and an inverting circuit 24 which comprises push-pull amplifiers. The structure of the local oscillator balun shown in FIG. 4 will be below described.

The complementary output converting circuit 21 of a single input will be first described in detail.

First and second resistors R41 and R42 are connected between the power supply terminal Vcc, and first and second nodes Q41 and Q42, respectively. A first NMOS transistor N41 is connected between the first node Q41 and the third node Q43 and a gate terminal of the first NMOS transistor N41 is applied with a local oscillating signal LO and a specific bias voltage VB via a third resistor R43. A second NMOS transistor N42 is connected between the second node Q42 and the third node Q43 and a gate terminal of second NMOS transistor N42 is applied with a specific bias voltage via the ground terminal Vss and the fourth resistors R44. Third and fourth NMOS transistors N43 and N44 driven depending on a given bias are serially connected between the third node Q43 and the ground terminal Vss. A first capacitor C41 is connected between an input terminal of the local oscillating signal LO and the gate terminal of the first NMOS transistor N41. A second capacitor C42 is connected between the ground terminal Vss and the gate terminal of the second NMOS transistor N42. A third capacitor C43 is connected between the gate terminal of the fourth NMOS transistor N44 and the ground terminal Vss. At this case, the potential voltage of the first node Q41 is the first output signal O1+ and the potential of the second node Q42 is the second output signal O1−.

A construction of the differential amplification circuit 22 will be below described in detail.

Fifth and sixth resistors R45 and R46 are connected between the power supply terminal Vcc, and fourth and fifth nodes Q44 and Q45, respectively. A fifth NMOS transistor N45 driven depending on a second output signal O1− is connected between the fourth node Q44 and the sixth node Q46. A sixth NMOS transistor N46 driven depending on the first output signal O1+ is connected between the fifth node Q45 and the sixth node Q46. A seventh NMOS transistor N47 driven depending on a given bias is connected between the sixth node Q46 and the ground terminal Vss. A fourth capacitor C44 is connected between an input terminal of the second output signal O1− and a gate terminal of the fifth NMOS transistor N45. A fifth capacitor C45 is connected between an input terminal of the first output signal O1+ and a gate terminal of the sixth NMOS transistor N46. Further, a specific bias voltage VB via the seventh resistor R47 is applied to the gate terminal of the fifth NMOS transistor N45. A specific bias voltage VB via the eighth resistor R48 is applied to a gate terminal of the sixth NMOS transistor N46. In the above, the fourth node Q45 is the first output terminal OUT+ and the fifth node Q45 is the second output terminal OUT−.

A construction of the inverting circuit 24 composed of push-pull amplifiers will be below described in detail.

A first PMOS transistor P41 driven depending on the potential of the first output terminal OUT+ is connected between the power supply terminal Vcc and the seventh node Q47. An eighth NMOS transistor N48 driven depending on the potential of the first output terminal OUT+ is connected between the seventh node Q47 and the ninth node Q49. Further, a ninth resistor R49 for controlling the initial state of the balun is connected between the first output terminal OUT+ and the seventh node Q47. A second PMOS transistor P42 driven depending on the potential of the second output terminal OUT− is connected between the power supply terminal Vcc and the eighth node Q48. A ninth NMOS transistor N49 driven depending on the potential of the second output terminal OUT− is connected between the eighth node Q48 and the ninth node Q49. Also, a tenth resistor R50 for controlling the initial state of the balun is connected between the second output terminal OUT− and the eighth node Q48. In addition, a tenth NMOS transistor N50 driven depending on a given bias, for controlling the current of the balun is connected between the ninth node Q49 and the ground terminal Vss. Meanwhile, the seventh node Q47 is the first output terminal OUT1 and the eighth node Q48 is the second output terminal OUT2.

As above, the local oscillator balun using the inverting circuit according to the present invention is composed of three stages. The complementary output converting circuit 21 having a single input terminal includes differential amplifiers for making a weak signal, which is inputted from the local oscillator as a single complementary output. The differential amplification circuit 22 produces voltage of amplitude enough to drive the push-pull amplifier composed of the inverting circuit 24, using a resistive load depending on the output of the complementary output converting circuit 21 as a single input.

The inverting circuit 24 composed of the push-pull amplifiers finally outputs a signal for driving the frequency mixer circuit depending on the output of the differential amplification circuit 22. The complementary output converting circuit 21 and the differential amplification circuit 22 have common CMOS differential amplifier structures. In case of the load resistor 23, a load using an inductor or an inductor-capacitor (LC) resonator circuit is used instead of the resistive load. In this case, though the output voltage amplitude can be increased, there may be a problem that it does not have a wideband characteristic. The two push-pull amplifiers constituting the inverting circuit 24 receive first and second outputs of the differential amplifier 22 and a CMOS push-pull amplifier similar to a logic inverting circuit. The basic structure of the inverting circuit 24 comprises a logic inverting circuit and it includes a PMOS transistor and a NMOS transistor, The operations of the PMOS transistor and the NMOS transistor are dependent on an input voltage, which will be described below.

If a voltage of a LOW state as an input signal, which is a voltage of a ground potential Vss, is applied, the PMOS transistor turned on to maintain a shortage state. Thus, a voltage of the power supply Vcc is outputted to the output of the inverting circuit. At this case, the NMOS transistor is maintained to be off state so that the NMOS transistor remain the state of the shortage with output terminal. On the contrary, if a voltage of a HIGH state, a voltage of the power supply Vcc, is applied, the PMOS transistor is kept to be off state and the NMOS transistor turned on. Thus, the output is applied with the ground voltage Vss. As such, it is called the inverting circuit since the input and output are always reversed. The output is changed from the power supply Vcc to the ground voltage Vss. Further, when the input is shifted from a LOW state to a HIGH state, the operation of the NMOS transistor and PMOS transistor is changed within a short period of time in the normal operation state described above. At an intermediate voltage between the ground voltage Vss and the power supply Vcc, two types of transistors can have the ON state. However, this state is not usually used. Thus, this state can maintain in a short time since the signal continuously changes.

The operating speed of the inverting circuit is varied depending on the area of the transistor and may be differently designed depending on desired speed and characteristic. Further, in view of the load driving, the voltage of the power supply Vcc and the voltage of the ground voltage Vss are connected to the load depending on LOW and HIGH states of the input, so that charging and discharging are performed. Thus, the inverting circuit can be rapidly operated. In a state that charging and discharging are completed, current flows no longer. Therefore, even though a large capacitive load exists, an output having rapid speed characteristic and high voltage amplitude can be generated. This operation is will disclosed in general electronic circuit related documents, for example, “Circuit Design for CMOS VLSI” (Chapter 3, The CMOS Inverter) written by Kluwer Academic Publishers, John P. Uyemura.

The push-pull amplifier of two logic inverting circuit shapes composed of these NMOS transistor and PMOS transistor is connected to the local oscillating frequency input terminal of the Gilbert type double balance frequency mixer. Thus, a lot of current can be supplied to a high capacitive and resistive load within a short period time so that the load is charged or discharged. In this manner, a driving capability of high load can be implemented. Further, as the output amplitude can obtain high voltage amplitude from the power supply voltage being a characteristic of the push-pull amplifier to the ground voltage, a switching operation of the CMOS device being a local oscillating frequency means in the frequency miser is made possible. As a result, a condition that the maximum mixing gain of the frequency mixer can be realized is accomplished and its explanation is shortly described in the description of the prior art in this application. In addition, the circuit of the present invention has a switching characteristic of rapid transition time in the push-pull amplifier against the high capacitive load. Thus, as a result of simulation, the circuit of the present invention can reduce the phase difference by 20% compared to a general differential amplifier in a conventional circuit. As a result, the leakage signal of the frequency mixer is made small to improve the performance of the frequency mixer.

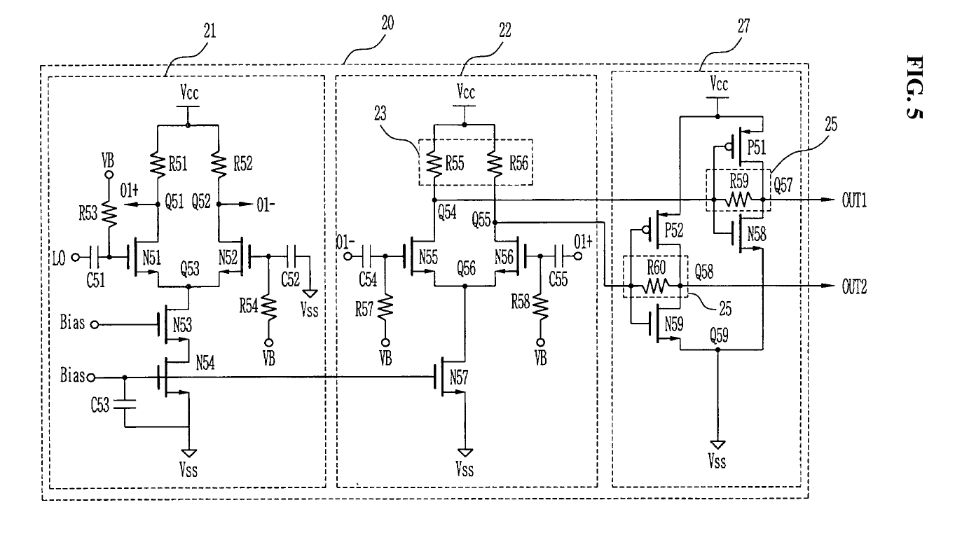

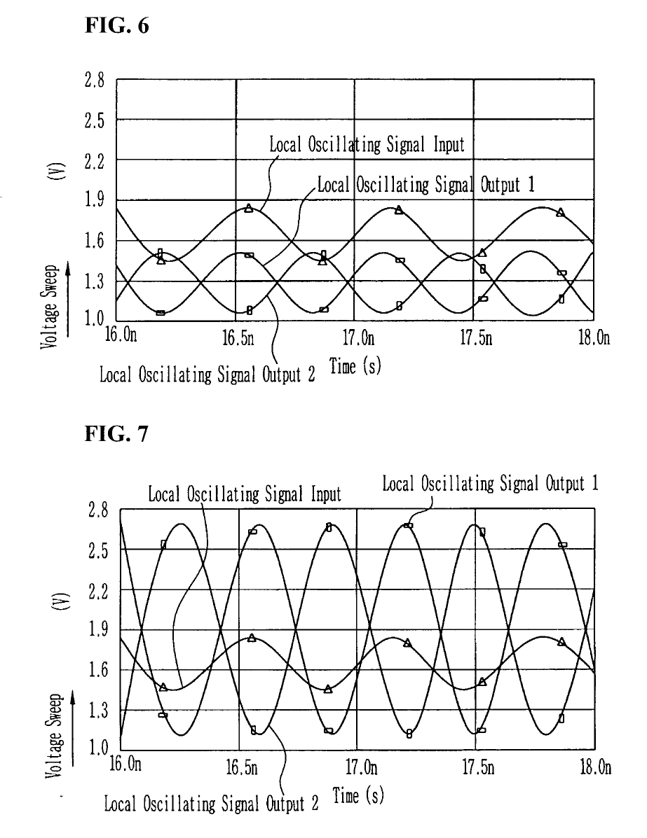

In case of the balun circuit using the inverting circuit in FIG. 4, a stable operation of the initial state can be implemented using the resistor 25 for controlling the initial state. The second embodiment comprises the balun circuit using the inverting circuit in use of the current control device in the first embodiment and the maximum operation current circuit are included is shown in FIG. 5. In the above, the inverting circuit 24 having the tenth NMOS transistor that drives as a specific current depending on an external bias potential does not limit current. The inverting circuit 27 of other shape that is driven with the maximum current in which the transistor can be driven. Thus, the circuits 24 and 27 can be distinctly used depending on a desired characteristic of the system.

As mentioned above, as a result of simulating the local oscillator balun using the inverting circuit according to the present invention, it could be seen that the driving amplitude can be significantly improved as shown in FIG. 7. Further, it can be seen that the phase difference of the two complementary outputs is reduced by at least 30%. Therefore, the present invention can reduce the leakage in the mixing gain and the local oscillating signal of the frequency mixer and thus improve the noise characteristic to implement a good frequency mixer.

Further, due to a driving capability and a driving voltage for driving high resistive and capacitive load even at an input of a fine local oscillating signal, a load on the driving in the output circuit is reduced in designing an external local oscillating frequency generating circuit, so that the circuit can be easily implemented in the entire system implementation.

[Table 1] shows a result of comparing a circuit of the present invention to a conventional circuit.

TABLE 1

| | Conventional | Present |
|---|---|---|
| | Circuit | Circuit |
| Local Oscillating Signal | 0.48 | 1.53 |
| Voltage Amplitude (V_{P-P}) | | |
| Local Oscillating Signal | 2.7 degree | 2 degree |
| Output Phase Difference (degree) | | (improved by |
| (@1.65 GHz) | | 30%) |

The present invention has been described with reference to a particular embodiment in connection with a particular application. Those having ordinary skill in the art and access to the teachings of the present invention will recognize additional modifications and applications within the scope thereof.

It is therefore intended by the appended claims to cover any and all such applications, modifications, and embodiments within the scope of the present invention.

What is claimed is:

1. A local oscillator balun using an inverting circuit, comprising:
a complementary output converting circuit for amplifying a weak signal as a single signal from a local oscillator to produce two signals;
a differential amplification circuit for producing two signals having a given amplitude from the two signals of said complementary output converting circuit; and
an inverting circuit for inverting the two signals of the differential amplification circuit.

2. The local oscillator balun using an inverting circuit as claimed in claim 1, wherein said inverting circuit is composed of CMOS push-pull amplifiers.

3. The local oscillator balun using an inverting circuit as claimed in claim 1, wherein said inverting circuit includes a resistor for controlling the initial state of the inverting circuit.

4. The local oscillator balun using an inverting circuit as claimed in claim 1, wherein said inverting circuit includes a current limit means that is driven depending on a given bias in order to control the current of the inverting circuit.

5. The local oscillator balun using an inverting circuit as claimed in claim 1, wherein said inverting circuit includes a resistor for controlling the initial state of the inverting circuit.
